(19) United States
(12) Patent Application Publication
(10) Pub. No.: US 2012/0307153 A1
(43) Pub. Date: Dec. 6, 2012

(54) VIDEO PROCESSING DEVICE AND VIDEO PROCESSING METHOD

(75) Inventors: Katsumi TERAI, Osaka (JP); Yoshihiro Kishimoto, Osaka (JP)

(73) Assignee: PANASONIC CORPORATION, Osaka (JP)

(21) Appl. No.: 13/570,935

(22) Filed: Aug. 9, 2012

Related U.S. Application Data
(63) Continuation of application No. PCT/JP2011/000679, filed on Feb. 8, 2011.

(30) Foreign Application Priority Data
Feb. 15, 2010 (JP) 2010-030684

(51) Int. Cl. H04N 5/14

(52) U.S. Cl. 348/571; 348/E05.062

(57) ABSTRACT

A video processing device generates a second video signal from a first video signal. The first video signal includes an image having a mix of pixels for viewpoints that are different from each other. The second video signal is higher in frame rate than the first video signal. The video processing device includes: a viewpoint control unit obtaining, for each of the viewpoints from the first video signal, pixel data for the viewpoint; and an image generating unit generating an interpolated image by generating, for each of viewpoints from the pixel data obtained by the viewpoint control unit, pixel data for interpolation for the viewpoint.

### CROSS REFERENCE TO RELATED APPLICATIONS

This is a continuation application of PCT Patent Application No. PCT/JP2011/000679 filed on Feb. 8, 2011, designating the United States of America, which is based on and claims priority of Japanese Patent Application No. 2010-030684 filed on Feb. 15, 2010. The entire disclosures of the above-identified applications, including the specifications, drawings and claims are incorporated herein by reference in their entirety.

### TECHNICAL FIELD

The present invention relates to a video processing device and a video processing method which generate an interpolated image from a first video signal including an image having a mix of pixels corresponding to multiple different viewpoints.

### BACKGROUND ART

Recently, flat panel displays are typically used as display units for TVs. In particular, liquid crystal panels account for a significant proportion of the flat panel displays. Among such TVs, increasing its share is the high-speed-driving liquid crystal TV that makes up for a slow video response, and achieves high image quality. In the high speed driving, the display frame rate is twice as fast as a frame rate of the original video signal.

Meanwhile, the three dimensional (stereoscopic or 3D) TV is attracting attention as a next-generation TV, and various techniques are being proposed for the TV. In providing 3D display, there are a variety of 3D display techniques, such as a technique based on a one-channel video (Cathode-Ray-Tube based 3D display using glasses whose liquid crystal shutters open and close), and a technique based on a two-channel video (3D display using two projectors). For example, Patent Literature 1 discloses a digital broadcasting receiving device which can compatible with multiple broadcasting techniques. In the 3D display, the device can reproduce and display broadcasts on a 3D display technique which the user designates.

Another 3D display technique for a flat panel display utilizes glasses equipped with polarizing filters each having a different angle for the right eye and the left eye, instead of the above glasses equipped with shutters to open and close. Here, all the display pixels in the flat panel display are equally divided into pixels for the left eye and pixels for the right eye. The polarizing filters are provided with a different angle for the left-eye pixels and the right-eye pixels.

### CITATION LIST

### Patent Literature

[PTL 1] Japanese Unexamined Patent Application Publication No. 10-257526

### SUMMARY OF INVENTION

### Technical Problem

An interpolated image could be generated from a video signal which complies with a 3D format that causes parallax between the left eye and the right eye. The generation of the interpolated image, however, can develop a problem of image quality deterioration. In typical generation of an interpolated image for a 2D video, a frame image is interpolated based on a motion vector between a pair of continuous frames. In the 3D format, a mix of pixels for the left eye and pixels for the right eye is provided in one frame. This mixture, however, makes it difficult to accurately detect the motion vector, leading to image quality deterioration.

FIG. 9A shows a 3D format which is referred to as a checkered format. The 3D format has each of the pixels for the left eye (white pixels in FIG. 9A) and for the right eye (black pixels in FIG. 9A) alternately arranged in row and column directions. The pixels for the left eye and for the right eye that show a 3D object have a displacement amount (also referred to as offset) at their positions in order to develop parallax. The pixels for the left eye and for the right eye having the displacement amount are arranged in a mix, neighboring with each other. Such an arrangement causes the 3D object of the format to be displaced, and generates a 2D image having two images displaced with each other. Consequently, the conventional motion vector detecting processing cannot accurately detect the motion vector.

FIG. 9B shows another 3D format which is referred to as a line-sequential format. The 3D format has pixels for the left eye (white pixels in FIG. 9B) and pixels for the right eye (black pixels in FIG. 9B) alternately arranged only in a vertical direction. In the 3D format, as well as the former 3D format, the conventional motion vector detecting processing cannot accurately detect the motion vector because of the above reason. Consequently, the deterioration in image quality can develop.

Such image quality deterioration can occur not only in generating an interpolated image based on a motion vector. The image quality deterioration can occur when, for example, a linearly-interpolated image is generated in the format shown in FIG. 9A.

The present invention has an object to provide a video processing device which generates an interpolated image without deteriorating image quality in 3D display.

### Solution to Problem

In order to solve the above problems, a video processing device according to an aspect of the present invention generates an interpolated image from a first video signal including an image having a mix of pixels corresponding to viewpoints that are different from each other. The video processing device includes: a viewpoint control unit which obtains, for each of the viewpoints from the first video signal, pixel data corresponding to the viewpoint; and an image generating unit which generates an interpolated image by generating, for each of the viewpoints from the pixel data obtained by the viewpoint control unit, pixel data for interpolation for the viewpoint.

According to the structure, the viewpoint control unit obtains, for each viewpoint, pixel data corresponding to the viewpoint from the first video signal. The image generating unit generates, for each viewpoint, pixel data for interpolation from the pixel data obtained for the viewpoint, and further generates an interpolated image. The video processing device generates an independent interpolated image for each viewpoint. Thus, in generating the interpolated image, the video processing device is free from an effect of a displacement amount corresponding to the parallax between the viewpoints. This feature successfully prevents deteriorating the quality of a 3D image.

Here, the image generating unit may generate a second video signal which includes the pixel data (i) including the interpolated image, (ii) corresponding to an arrangement of pixels for a display panel, and (iii) corresponding to each of the viewpoints, and the viewpoint control unit may obtain the pixel data of the first video signal for each of the viewpoints so that the obtained pixel data matches an arrangement of pixels for the second video signal.

These features make it possible to generate an interpolated image without deteriorating the quality of a 3D image, and to efficiently convert the pixel arrangement of the first video signal to the pixel arrangement for the second signal (format conversion) in the case where the pixel arrangement differs between the first video signal and the second video signal.

Here, the viewpoint control unit may associate a pixel address in an arrangement of the pixels for the first video signal with a pixel address in the arrangement of the pixels for the second video signal so as to obtain the pixel data of the first video signal for each of the viewpoints from the first video signal based on the pixel address in the arrangement of the pixels for the second video signal.

This feature makes it possible to make a format conversion, that is to convert the pixel arrangement of the first video signal to the pixel arrangement for the second signal, fast by the viewpoint control unit associating the pixel addresses with each other. In addition, a memory to store the image in the second video signal eliminates the need for doubly-storing images before and after the format conversion. This feature makes it possible to minimize the memory area for the format conversion, which contributes to reducing the cost.

Here, the video processing device may further include a motion information detecting unit which detects, for each of the viewpoints from the pixel data obtained by the viewpoint control unit, motion information of an image for the viewpoint. The image generating unit may generate the interpolated image for each of the viewpoints by generating pixel data for interpolation for the viewpoint based on the motion information for the viewpoint.

This feature makes it possible to accurately detect motion information, and to generate an interpolated image without deteriorating the quality of an interpolated image and therefore a 3D image.

Here, the viewpoint control unit may include: a first viewpoint control unit which obtains, for each of the viewpoints from the first video signal, the pixel data corresponding to the viewpoint, and to provides the obtained pixel data to the image generating unit; and a second viewpoint control unit which obtains, for each of the viewpoints from the first video signal, the pixel data corresponding to the viewpoint, and provides the obtained pixel data to the motion information detecting unit.

This feature makes it possible to execute pipelining the motion detection by the motion detecting unit and the image generation by the image generating unit, which contributes to achieving a higher frame rate. For example, the feature is suitable to convert a frame rate to a faster one than a double speed and a conversion of film footage to a frame rate of a display panel.

Here, the video processing device may include an image storage unit which temporarily stores one or more frames of image found in the first video signal. The viewpoint control unit may obtain, for each of the viewpoints from the image storage unit, the pixel data corresponding to the viewpoint, and may provide the obtained pixel data to the image generating unit.

This feature successfully converts a format so that the pixel arrangement of the first video signal converts to the pixel arrangement for the second video signal, without deteriorating the quality of a 3D image.

Here, the video processing device may include an image storage unit which temporarily stores the first video signal. The image storage unit may store one or more frames of image found in the first video signal. The first viewpoint control unit may obtain, for each of the viewpoints from the image storage unit, the pixel data corresponding to the viewpoint, and may provide the obtained pixel data to the image generating unit. The second viewpoint control unit may obtain, for each of the viewpoints from the image storage unit, the pixel data corresponding to the viewpoint, and may provide the obtained pixel data to the motion information detecting unit.

This feature makes it possible to execute pipelining the motion detection by the motion detecting unit and the image generation by the image generating unit, which contributes to achieving a higher frame rate. For example, the feature is suitable to convert a frame rate to a faster one than a double speed and a conversion of film footage to a frame rate of a display panel.

Here, the first viewpoint control unit may associate a pixel address in an arrangement of the pixels for the first video signal with a pixel address in an arrangement of pixels for a second video signal so as to obtain the pixel data of the first video signal for each of the viewpoints from the first video signal based on the pixel address in the arrangement of the pixels for the second video signal.

This feature makes it possible to make a format conversion; that is to convert the pixel arrangement of the first video signal to the pixel arrangement for the second signal, fast by an address conversion of the storage area in the image storage unit. In addition, the image storage unit eliminates the need for doubly-storing images before and after the format conversion. This feature makes it possible to minimize the memory area for the format conversion, which contributes to reducing the cost.

Here, the image generating unit may generate the interpolated image by applying, to the pixel data obtained by the viewpoint control unit for each of the viewpoints, at least one of (a) interpolation based on motion information, (b) linear interpolation, and (c) interpolation by frame duplication.

This feature makes it possible to decrease a processing amount and a processing load in generating an interpolated image when (b) the interpolated image is generated by the linear interpolation. Hence, the hardware size is successfully reduced. This feature makes it possible to decrease a processing amount and a processing load in generating an interpolated image when (c) the interpolated image is generated by duplication. Consequently, the interpolated image is generated without increasing the hardware size. The interpolation using at least one of (a) to (c) successfully offers a flexible response over the processing amount and the processing speed.

Here, the image generating unit may insert the interpolated image between pictures in the first video signal to generate the second video signal. The second video signal may have a frame rate higher than that of the first video signal.

Here, the frame rate of the second video signal is twice or four times as high as that of the first video signal.

This feature makes it possible to convert a frame rate as fast as an n-time speed (for example, a double frame-rate conversion and a quadruple frame-rate conversion).

Here, the first video signal may have a frame rate for movie film, and the second video signal may have a frame rate for TV broadcasting or for a display panel.

This feature is suitable to convert a video signal of movie film to a frame rate of the display panel.

Here, the first video signal may have a frame rate for the Phase Alternation by Line (PAL) TV broadcasting, and the second video signal may have a frame rate for the National Television System Committee (NTSC) TV broadcasting.

This feature makes it possible to convert a PAL video signal to an NTSC video signal.

Here, the image generating unit may generate the second video signal including an image having the interpolated image and part of the first video signal. The second video signal may have a frame rate lower than that of the first video signal.

This feature makes it possible to lower the frame rate of the first video signal, and to replace the frame with an interpolated image while maintaining the same frame rate.

Here, the first video signal may have a frame rate for the NTSC TV broadcasting, and the second video signal may have a frame rate for the PAL TV broadcasting.

This feature makes it possible to convert an NTSC video signal to a PAL video signal.

Here, the image generating unit may generate a second video signal including the interpolated image. The second video signal may have the same frame rate as that of the first video signal. The image generating unit may replace part of an image in the first video signal with the interpolated image so as to generate the second video signal.

This feature makes it possible to perform de-juddering on, for example, a 2-3 pull-downed first video signal by duplication, using an interpolated image having a motion vector. Consequently, the motion of the second video signal can be smoother than that of the first video signal.

A video processing method according to an aspect of the present invention involves generating an interpolated image from a first video signal including an image having a mix of pixels corresponding to viewpoints that include at least a first viewpoint and a second viewpoint and are different from each other. The video processing method includes: obtaining, from the first video signal, pixel data corresponding to the first viewpoint; generating, from the obtained pixel data corresponding to the first viewpoint, pixel data for interpolation corresponding to the first viewpoint; obtaining, from the first video signal, pixel data corresponding to the second viewpoint; generating, from the obtained pixel data corresponding to the second viewpoint, pixel data for interpolation corresponding to the second viewpoint; and generating an interpolated image from the pixel data for interpolation corresponding to the first viewpoint and the pixel data for interpolation corresponding to the second viewpoint.

According to the structure, the method involves (i) obtaining, for each of viewpoints, pixel data corresponding to the viewpoint from the first video signal, (ii) generating, for each of the viewpoints, pixel data for interpolation from the pixel data obtained for the viewpoint, and (iii) further generating an interpolated image. Since the method involves generating an independent interpolated image for each viewpoint, the method is free from an effect of a displacement amount between viewpoints (or a displacement amount). This feature contributes to achieving a higher frame rate without deteriorating the quality of a 3D image.

### Advantageous Effects of Invention

A video processing device according to an implementation of the present invention generates an interpolated image without an effect of a displacement amount between the viewpoints. This feature contributes to generating the interpolated image without deteriorating the quality of a 3D image.

Moreover, the video processing device achieves both of a higher frame rate and a conversion of a pixel arrangement of the first video signal to a pixel arrangement for the second video signal without deteriorating the quality of a 3D image.

Moreover, the video processing device achieves a format conversion; that is to convert the pixel arrangement of the first video signal to the pixel arrangement for the second signal, fast by an address conversion of the storage area in the image storage unit.

In addition, the video processing device eliminates the need for doubly-storing images before and after the format conversion. This feature makes it possible to minimize the memory area for the format conversion, which contributes to reducing the cost.

### BRIEF DESCRIPTION OF DRAWINGS

These and other objects, advantages and features of the invention will become apparent from the following description thereof taken in conjunction with the accompanying drawings that illustrate a specific embodiment of the present invention. In the Drawings:

FIG. 1 depicts a block diagram showing a structure of major units of a video processing device according to Embodiment 1;

FIG. 2A shows a checkered format according to Embodiment 1;

FIG. 2B shows another checkered format according to Embodiment 1;

FIG. 2C shows a line-sequential format according to Embodiment 1;

FIG. 2D shows another line-sequential format according to Embodiment 1;

FIG. 2E shows a vertical-interleaving format according to Embodiment 1;

FIG. 2F shows another vertical-interleaving format according to Embodiment 1;

FIG. 3A shows a side-by-side format (full rate) according to Embodiment 1;

FIG. 3B shows a side-by-side format (half rate) according to Embodiment 1;

FIG. 3C shows a frame-sequential format (interlace) according to Embodiment 1;

FIG. 3D shows a frame-sequential format (progressive) according to Embodiment 1;

FIG. 4 depicts a block diagram showing a structure of major units of a video processing device according to Embodiment 2;

FIG. 5 depicts a block diagram showing a modification of the major units of the video processing device according to Embodiment 2;

FIG. 6 depicts a block diagram showing a structure of major units of a video processing device according to Embodiment 3;

FIG. 7A shows 2-3 pull down based on frame duplication;

FIG. 7B shows de-juddering based on motion-compensated interpolation according to Embodiment 3;

FIG. 8A shows a conversion from a PAL signal to a NTSC signal based on the motion-compensated interpolation according to Embodiment 3;

FIG. 8B shows a conversion from a NTSC signal to a PAL signal based on the motion-compensated interpolation according to Embodiment 3;

FIG. 8C shows how to generate a second video signal having the same frame rate as a first video signal has;

FIG. 9A shows a 3D format which is referred to as a checkered format; and

FIG. 9B shows a 3D format which is referred to as a line-sequential format.

### DESCRIPTION OF EMBODIMENTS

### Embodiment 1

A video processing device generates, from a first video signal, a second video signal of which frame rate is higher than the frame rate of the first video signal. Here, the first video signal includes an image having a mix of pixels for multiple different viewpoints. For each of the viewpoints, the video processing device obtains from the first video signal pixel data corresponding to the viewpoint, generates for each of the viewpoints, pixel data for interpolation from the pixel data obtained for the viewpoint, and generates an interpolated image. Since the video processing device generates an independent interpolated image for each viewpoint, the video processing device is free from an effect of a displacement amount between viewpoints (or a displacement amount). Consequently, the video processing device successfully achieves a higher frame rate without deteriorating the quality of a 3D image. An image generating unit 130 includes a first interpolating unit 31, a second interpolating unit 32 . . . , and an n-th interpolating unit 3n, and an output control unit 131.

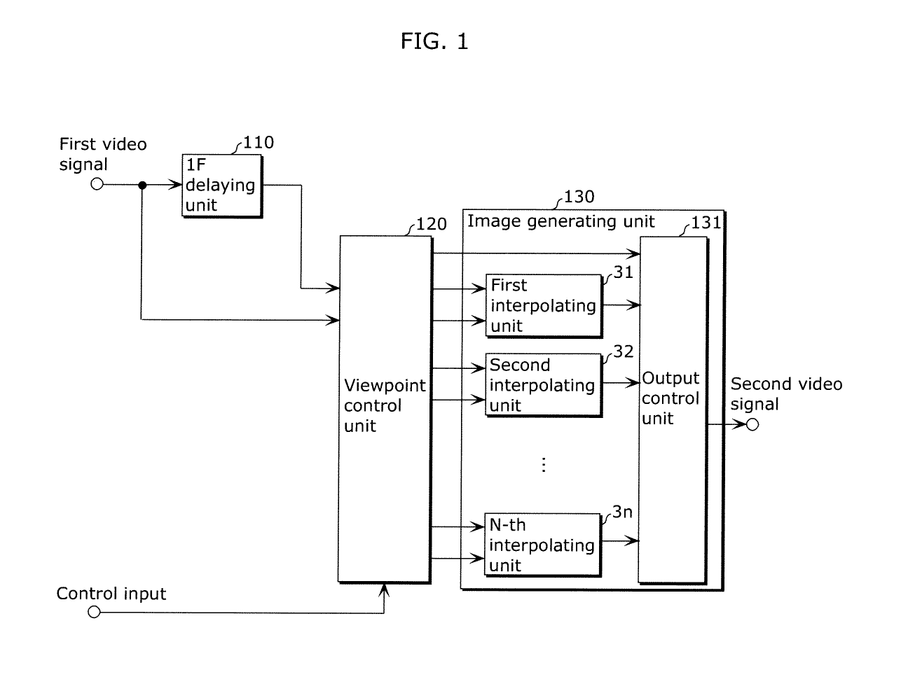

FIG. 1 depicts a block diagram showing a structure of major units of a video processing device according to Embodiment 1. The video processing device is a digital TV including a flat panel display such as a liquid crystal display panel, a plasma display panel, an electro luminescence display panel. FIG. 1 shows a structure of the major units related to the present invention. As shown in FIG. 1, the video processing device includes a 1F delaying unit 110, a viewpoint control unit 120, and the image generating unit 130.

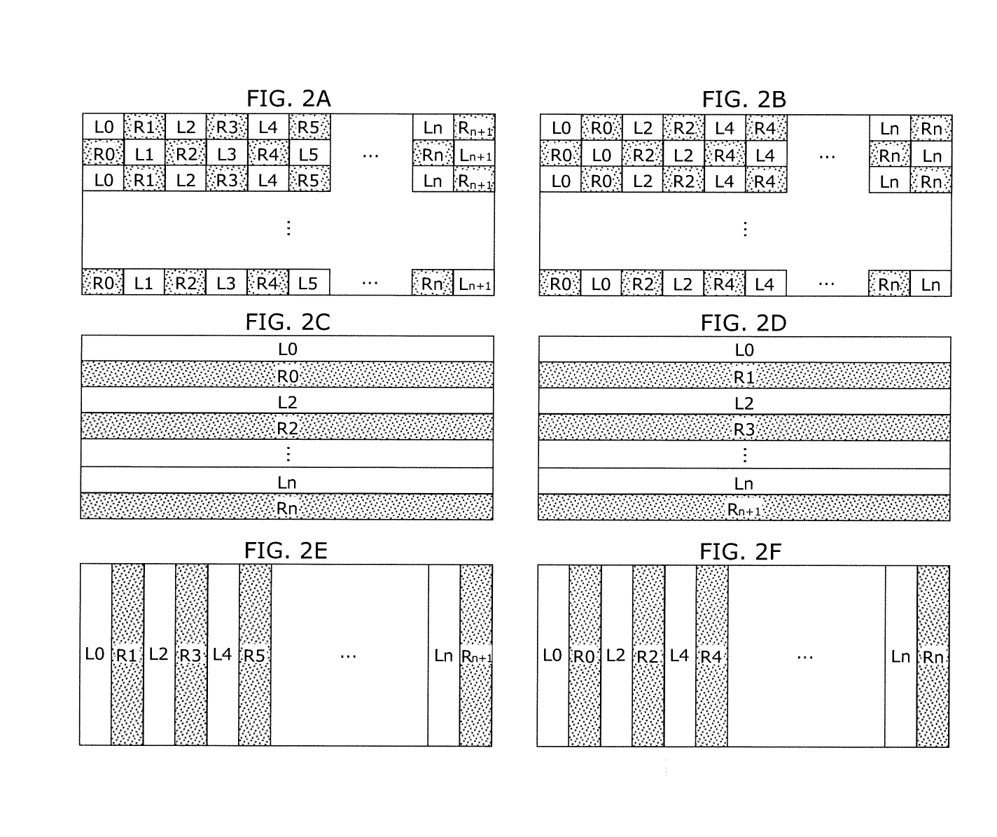

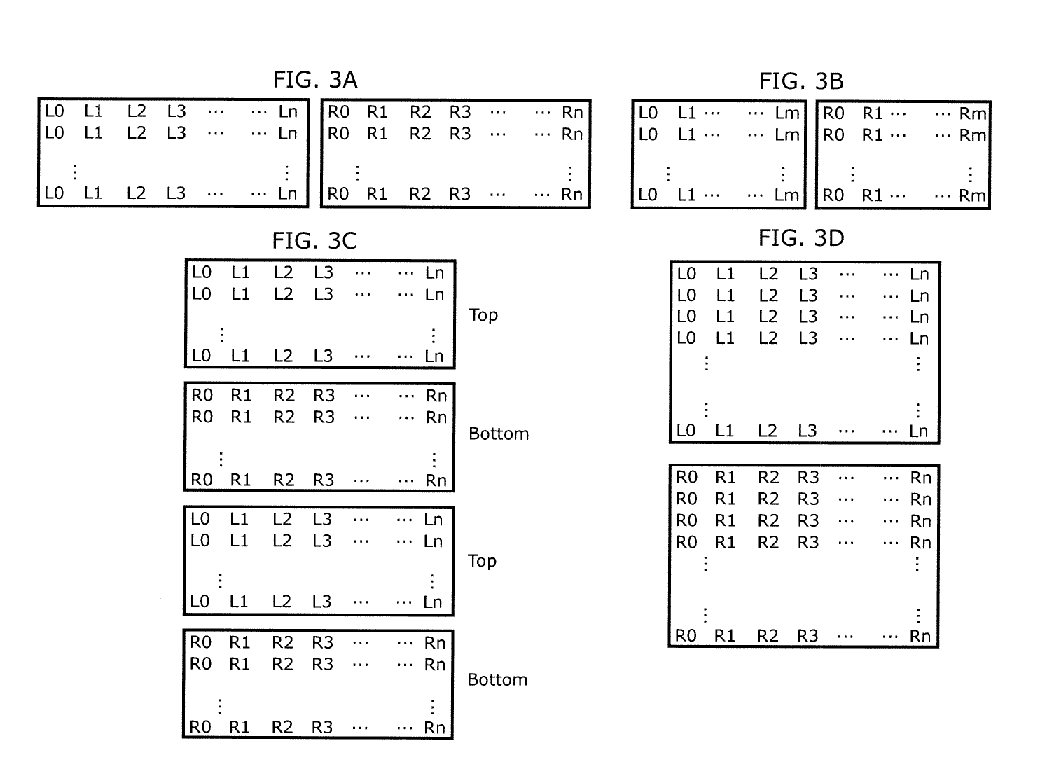

The 1F delaying unit 110 is a delay buffer which delays a provided first video signal for a time period of one frame. The 1F delaying unit stores an image obtained one frame time period before the currently provided image in the first video signal. Here, the first video signal is a video signal including an image having a mix of pixels corresponding to multiple different viewpoints. There are two or more of the viewpoints. Exemplified in FIGS. 2A to 2F and 3A to 3D are specific formats showing arrangements of pixels in the first video signal when there are two viewpoints.

FIGS. 2A and 2B show checkered formats. Each of the pixels for the left eye and for the right eye is alternately arranged in row and column directions. In FIGS. 2A and 2B, the pixels have a different centroid.

FIGS. 2C and 2D show line-sequential formats. The pixels for the left eye and the pixels for the right eye are alternately arranged only in a column direction. In FIGS. 2C and 2D, the pixels have a different centroid.

FIGS. 2E and 2F show vertical-interleaving formats. The pixels for the left eye and the pixels for the right eye are alternately arranged only in a row direction. In FIGS. 2E and 2F, the pixels have a different centroid.

FIGS. 3A and 3B show side-by-side formats. The pixels for the left eye and the pixels for the right eye are separated on the left and the right of the image. The difference between FIG. 3A and FIG. 3B is whether the format is full rate or half rate.

FIGS. 3C and 3D show frame-sequential formats. The difference between FIG. 3C and FIG. 3D is whether the format is interlace or progressive.

For each of the viewpoints, the viewpoint control unit 120 obtains pixel data corresponding to the viewpoint from both of a currently provided image in the first video signal and an image held in the 1F delaying unit 110.

The image generating unit 130 generates an interpolated image by generating, for each of the viewpoints from the pixel data obtained by the viewpoint control unit 120, pixel data for interpolation for the viewpoint. The image generating unit 130 generates the second video signal by inter-frame interpolating the first video signal.

Thus, the image generating unit 130 may include the first interpolating unit 31, the second interpolating unit 32, . . . the n-th interpolating unit 3n, and the output control unit 131. Here, n is the number of viewpoints equal to or greater than 2, and may be equal to or greater than the number of viewpoints for the first video signal. As a matter of convenience, each of the viewpoints is referred to as a first viewpoint, a second viewpoint . . . , and an n-th viewpoint. When n is 2, the first viewpoint and the second viewpoint correspond to an image for the left eye and an image for the right eye, respectively. It is noted that in FIG. 1, the first interpolating unit 31 to the n-th interpolating unit 3n are shown as n separate blocks. Instead, a single interpolating unit may be provided to carry out processing for n times by time division. Having one interpolating unit contributes to reducing a size of the circuit. In contrast, having n interpolating units allows the interpolating units to run concurrently, which contributes to a faster operation of the image generating unit 130.

The first interpolating unit 31 generates, from the pixel data obtained by the viewpoint control unit 120, a first-viewpoint pixel data for interpolation. Here the pixel data for interpolation is used for interpolating a frame. The second interpolating unit 32 and the n-th interpolating unit 3n are the same as the first interpolating unit 31 except that their view points are different from that of the first interpolating unit 31. Hence, the details thereof shall be omitted.

The output control unit 131 provides the second video signal with operating timing (vertical synchronization and horizontal synchronization) of the display panel.

As described above, the viewpoint control unit 120 according to Embodiment 1 obtains, for each of viewpoints from the first video signal, pixel data corresponding to the viewpoint. The image generating unit 130 generates, from the pixel data obtained for each of the viewpoints, pixel data for interpolation for the viewpoint, and further generates an interpolated image. Since the video processing device according to Embodiment 1 generates an independent interpolated image for each viewpoint, the video processing device is free from an effect of a displacement amount between viewpoints (or a displacement amount). This feature contributes to achieving a higher frame rate without deteriorating the quality of a 3D image.

It is noted that, as frame interpolation techniques, the first interpolating unit 31 to the n-th interpolating unit 3n may (i) utilize linearly interpolation and (ii) detect a motion vector and utilize motion-compensated interpolation based on the detected motion vector.

In addition to the frame interpolation, the image generating unit 130 may perform, as necessary, intra-frame interpolation on an original image in the first video signal. Furthermore, in addition to the frame interpolation, the image generating unit 130 may perform, as necessary, intra-frame interpolation on an original image in the second video signal. The intra-frame interpolation makes a format conversion easy even though the format differs between the second video signal and the first video signal.

### Embodiment 2

Embodiment 2 shows a video processing device which detects, from pixel data for each of viewpoints in the first video signal, motion information of an image for the viewpoint, and generates pixel data for interpolation for each viewpoint based on the motion information for the view point.

In addition, the video processing device converts an arrangement of pixels when the arrangement of the pixels corresponding to multiple viewpoints is different between the second video signal (second format) and the first video signal (first format). Any given format in FIGS. 2A to 2F and 3A to 3D may be a specific example of the first format. Any given format in FIGS. 2C to 2F may be the second format for the second video signal for a display panel having a polarizing filter on each of display pixels.

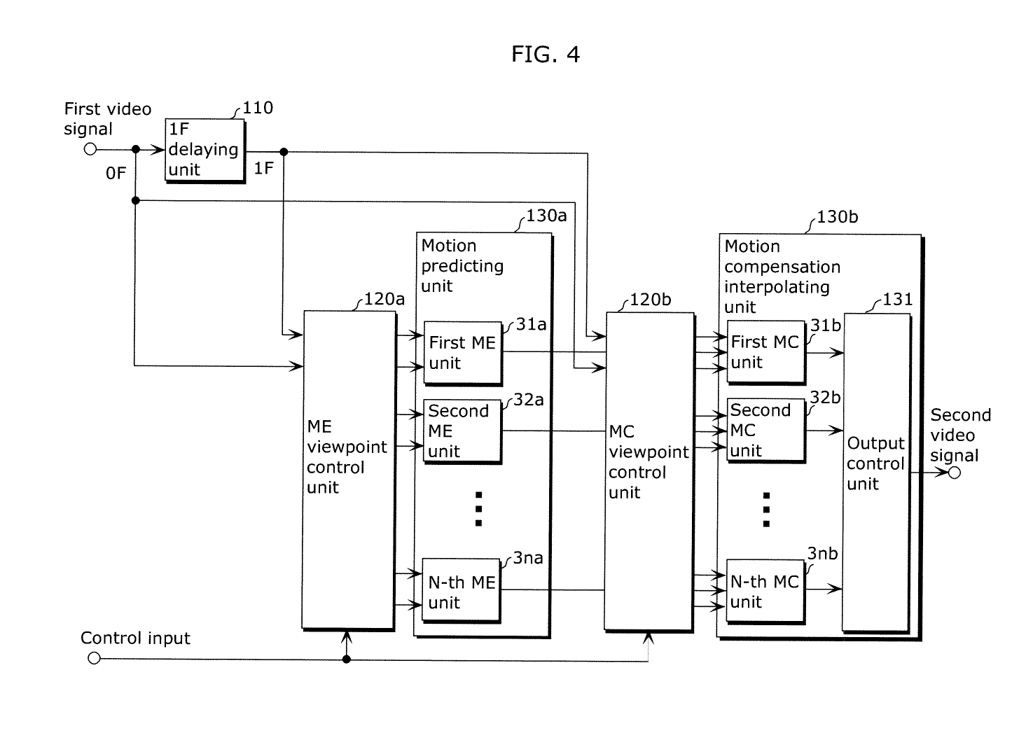

FIG. 4 depicts a block diagram showing a structure of major units of the video processing device according to Embodiment 2. The comparison shows that the video processing device in FIG. 4 differs from the video processing device in FIG. 1 in that the video processing device in FIG. 4 includes ME viewpoint control units 120a and 120b instead of the viewpoint control unit 120, and a motion predicting unit 130a and a motion-compensated interpolating unit 130b instead of the image generating unit 130. The motion predicting unit 130a includes a first ME unit 31a, a second ME unit 32a, . . . , and an n-th ME unit 3na. The motion-compensated interpolating unit 130b includes a first MC unit 31b, a second MC unit 32b, . . . , and an n-th MC unit 3nb, and the output control unit 131. Hereinafter, the differences between Embodiment 2 and Embodiment 1 are mainly discussed, and the same details therebetween shall be omitted.

For each of viewpoints, the ME viewpoint control unit 120a obtains, from a first video signal, pixel data corresponding to the viewpoint, and provides the obtained pixel data to the motion predicting unit 130a.

For each of viewpoints, the MC viewpoint control unit 120b obtains, from the first video signal, pixel data corresponding to the viewpoint, and provides the obtained pixel data to the motion-compensated interpolating unit 130b. In addition, when the arrangement of the pixels corresponding to multiple viewpoints is different between the second video signal (second format) and the first video signal (first format), the MC viewpoint control unit 120b obtains pixel data of the first video signal for each of the viewpoints to convert the pixel arrangement to that for the second video signal, and provides the obtained pixel to the motion-compensated interpolating unit 130b. In addition to providing a higher frame rate, this feature successfully converts a format so that the pixel arrangement of the first video signal converts to the pixel arrangement for the second video signal, without deteriorating the quality of a 3D image.

Described hereinafter is an exemplary structure of the motion-compensated interpolating unit 130b. The MC viewpoint control unit 120b includes an associating table unit which associates a pixel address in the arrangement of the pixels for the second video signal with a pixel address in the arrangement of the pixels for the first video signal. The MC viewpoint control unit 120b may use the associating table unit to convert the arrangement of the pixels for the first video signal to the arrangement of the pixels for the second video signal, and obtain pixel data of the first video signal for each of the multiple viewpoints based on the converted address.

The motion predicting unit 130a is an information detecting unit which detects, for each of viewpoints from pixel data obtained by the ME viewpoint control unit 120a, motion information (motion vector) of an image for the viewpoint.

The motion-compensated interpolating unit 130b generates an interpolated image for each of the viewpoints by generating pixel data for interpolation for the viewpoint based on the motion information for the viewpoint.

From the pixel data of a first viewpoint obtained by the ME viewpoint control unit 120a, the first ME unit 31a detects motion information (motion vector) of an image for the first viewpoint. The second ME unit 32a and the n-th ME unit 3na have a function similar to that of the first ME unit 31a except that they deal with a different viewpoint. Thus, their details shall be omitted.

It is noted that the first ME unit 31a to the n-th ME unit 3na are shown as n separate blocks. Instead, a single ME unit may be provided to carry out processing for n times by time division. Having one ME unit contributes to reducing a size of the circuit. In contrast, having n ME units allows the ME units to run concurrently, which contributes to making the image generating unit 130 to operate faster.

The first MC unit 31b generates pixel the data unit for interpolation for the first viewpoint, based on the motion information detected by the first ME unit 31a. The second MC unit 32b and the n-th MC unit 3nb have a function similar to the first ME unit 31a except that they deal with a different viewpoint. Thus, their details shall be omitted. It is noted that the first MC unit 31b to the n-th MC unit 3nb are shown as n separate blocks. Instead, a single MC unit may be provided to carry out processing for n times by time division. Having one MC unit contributes to reducing a size of the circuit. In contrast, having n MC units allows the MC units to run concurrently, which contributes to making the image generating unit 130 to operate faster. The first ME unit 31a and the first MC unit 31b correspond to the first interpolating unit 31 in Embodiment 1 that involves motion-compensated interpolation.

The video processing device according to Embodiment 2 can accurately detect motion information, and achieve a higher frame rate without deteriorating the quality of an interpolated image and therefore a 3D image.

Moreover, the address conversion contributes to achieving a faster format conversion of the first video signal in the first format to the second video signal for the second format. Since the video processing device eliminates the need for doubly-storing images before and after the format conversion. This feature makes it possible to minimize memory area for the format conversion, which contributes to reducing the cost.

It is noted that the 1F delaying unit 110 may include an image storage unit, such as a general-purpose dynamic random access memory (DRAM).

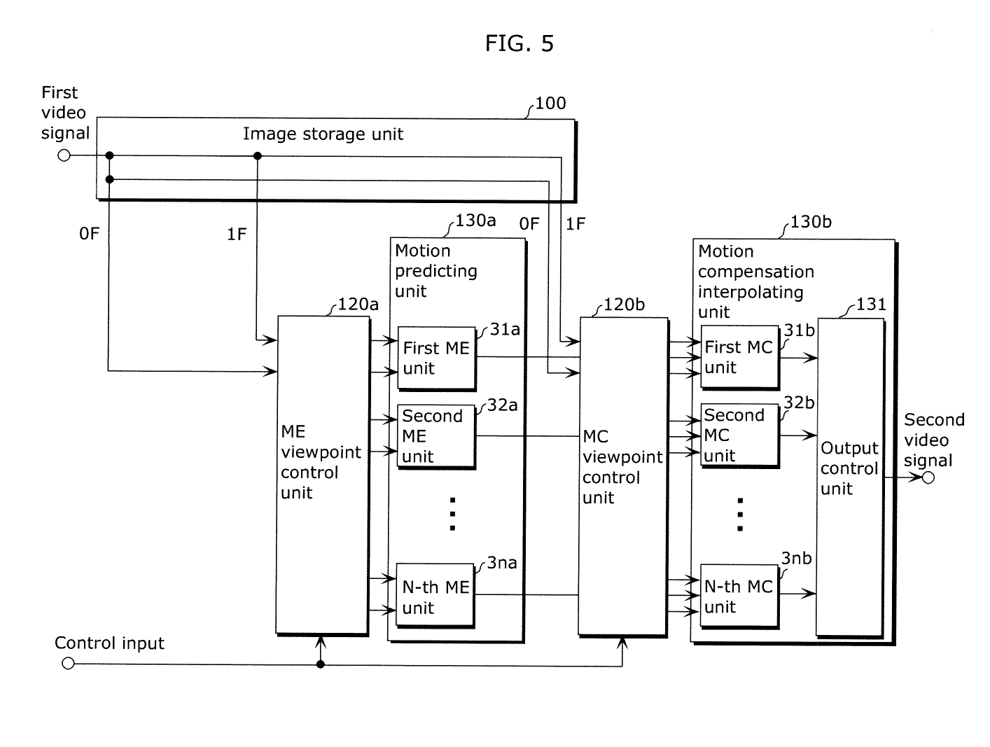

FIG. 5 depicts a block diagram showing a modification of the major units of the video processing device when the video processing device includes an image storage unit 100 instead of the 1F delaying unit 110.

According to the comparison, FIG. 5 differs from FIG. 4 in that the image storage unit 100 replaces the 1F delaying unit 110. Hereinafter, the differences between the image storage unit 100 and the 1F delaying unit 110 are mainly discussed, and the same details therebetween shall be omitted. The image storage unit 100 is a memory such as a DRAM. Furthermore, the image storage unit 100 may include a cash memory. This feature makes it possible to read data faster from the ME viewpoint control unit 120a and the MC viewpoint control unit 120b. It is noted that Embodiment 2 involves converting the first format to the second format via the address conversion. Instead, before the interpolation by the motion-compensated interpolating unit 130b, the image in the second format may be expanded to the memory (the image storage unit 100, for example) for each frame.

### Embodiment 3

Embodiment 3 shows a video processing device having 1F delaying units in two stages. This feature contributes to achieving a higher frame rate, such as a conversion to a frame rate faster than a double speed and a conversion of film footage to an image having a frame rate of a display panel.

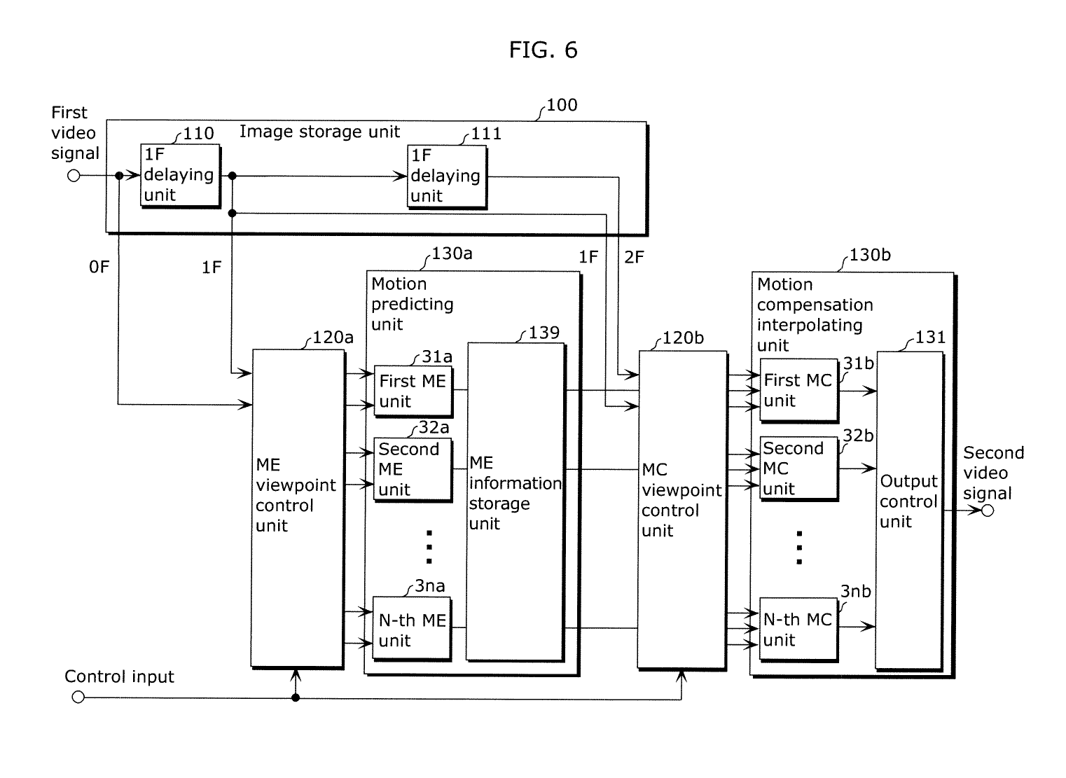

FIG. 6 depicts a block diagram showing a structure of major units of the video processing device according to Embodiment 3. According to the comparison, the video processing device in FIG. 6 differs from that in FIG. 6 in that the video processing device in FIG. 6 includes 1F delaying units 110 and 111, additionally has an ME information storage unit 139, and obtains the pixel data of the MC viewpoint control unit 120b from the 1F delaying units 110 and 111. Hereinafter, the differences between the video processing device in Embodiment 3 and the video processing device in Embodiment 2 are mainly described, and the same details therebetween shall be omitted.

In FIG. 6, “0F” denotes a frame image which is currently provided, “1F” denotes a frame image of one frame before the currently provided image, and “2F” denotes a frame image of two frames before the currently provided image.

The 1F delaying unit 111 is a storage area for the image storage unit 100, and is used for storing an image of two-frame time periods before the currently provided image of the first video signal.

The 1F delaying unit 111 temporarily (here, at least one-frame time period) stores a motion vector detected by the first ME unit 31a to the n-th ME unit 3na.

This structure makes it possible to execute in parallel motion detection by a motion detecting unit and image generation by an image generating unit for a different frame image. In other words, the executions can be pipelined. Such a feature is suitable to achieve a higher frame rate. For example, the feature contributes to achieving a higher frame rate, such as a conversion to a frame rate faster than a double speed and a conversion of film footage to an image having a frame rate of a display panel.

Described hereinafter are more specific operational examples such as (A) 2-3 pull down, (B) a conversion from a PAL signal to an NTSC signal, and (C) a conversion from an NTSC signal to a PAL signal.

First, (A) 2-3 pull down is described.

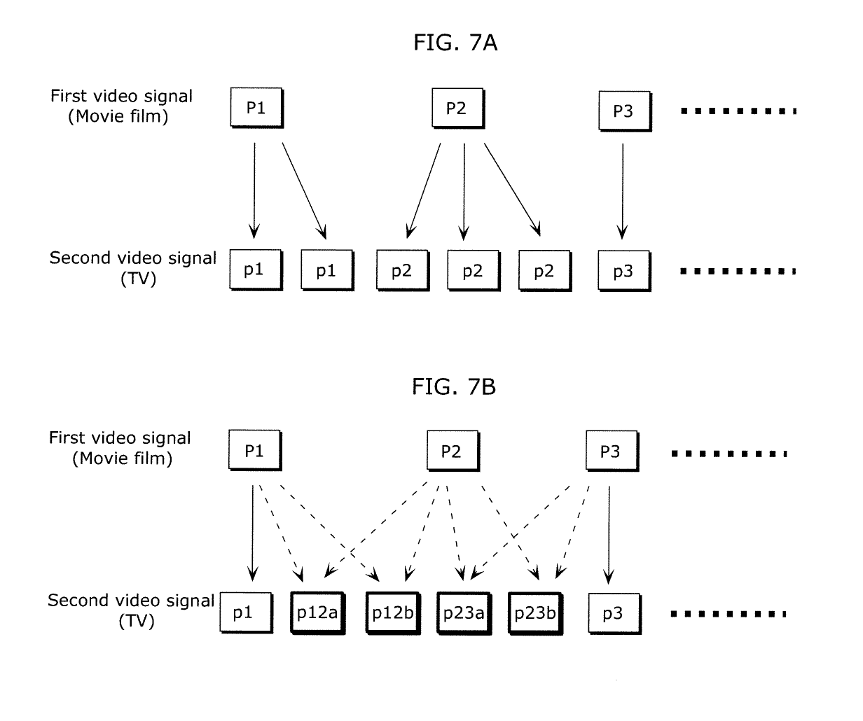

FIG. 7A shows 2-3 pull down based on a typical frame duplication.

The first video signal has a frame rate for movie film, and the frame rate is 24 frames a second. The second video signal has a frame rate for the NTSC, and the frame rate is 60 fields a second (30 frames a second).The squares P1 and P2 represent frame images.

The 2-3 pull down in FIG. 7A involves partial duplication of a frame P1 in the first video signal so as to generate two fields p1 for the second video signal, and involves partial duplication of a frame P2 so as to generate three fields p2 for the second video signal. Such duplication is repeated. The problem here is that the motion of the video is not smooth; in other words, the video becomes jumpy (develops judder).

FIG. 7B shows de-juddering based on motion-compensated interpolation according to Embodiment 3. The frame rates of the first video signal and the second video signal are the same as those shown in FIG. 7A. The difference from FIG. 7A is how to generate an interpolated image.

In the second video signal, the fields p1 and p3 shown in a thin-line square represent images generated by duplication (interpolation). In contrast, in the second video signal, the fields p12a, p12b, p23a, and p23b shown in a bold-line square represent interpolated images generated by motion-compensated interpolation.

For example, the motion predicting unit 130a and the motion-compensated interpolating unit 130b generate, as an interpolated image which corresponds to a field time for the field p12a, the field p12a for the second video signal in FIG. 7B based on at least one of the motion vector of the frame P1 and the motion vector of the frame P2. The fields p12b, p23a, and p23b are also generated in a similar manner.

Compared with the interpolated images p1 and p2 in FIG. 7A, each of the interpolated images p12a, p12b, p23a, and p23b reflects motion at a corresponding field time. This feature contributes to providing smooth motion, which improves image quality.

As described above, suppose the case where the first video signal has a frame rate for movie film, and the second video signal has a frame rate for TV broadcasting or for a display panel. For each of viewpoints, the ME viewpoint control unit 120a obtains from the first video signal pixel data corresponding to the viewpoint. The image generating unit (the motion predicting unit 130a and the motion-compensated interpolating unit 130b) generates for each of the viewpoints pixel data for interpolation from the obtained pixel data for each viewpoint, and generates an interpolated image. The video processing device generates an independent interpolated image for each viewpoint. Thus, in generating the interpolated image, the video processing device is free from an effect of a displacement amount corresponding to the parallax between the viewpoints. This feature successfully achieves a frame-rate conversion without deteriorating the quality of a 3D image.

It is noted that the frame rate of the first video signal (movie film) may be another frame rate, such as 25 frames a second and 18 frames a second. The frame rate of the second video signal does not have to be 60 fields a second. Here, the number of interpolated images generated by the image generating unit may be based on the ratio of the frame rate of the first video signal to the frame rate of the second video signal.

It is noted that, in FIG. 7B, when the frame rate of the second video signal is n times as fast as that of the first video signal, the frame rate of the second video signal may be converted to a frame rate as fast as an n-time speed. An integer, such as two and four, and a real number may represent n.

Described next is: (B) a conversion from a PAL signal to an NTSC signal.

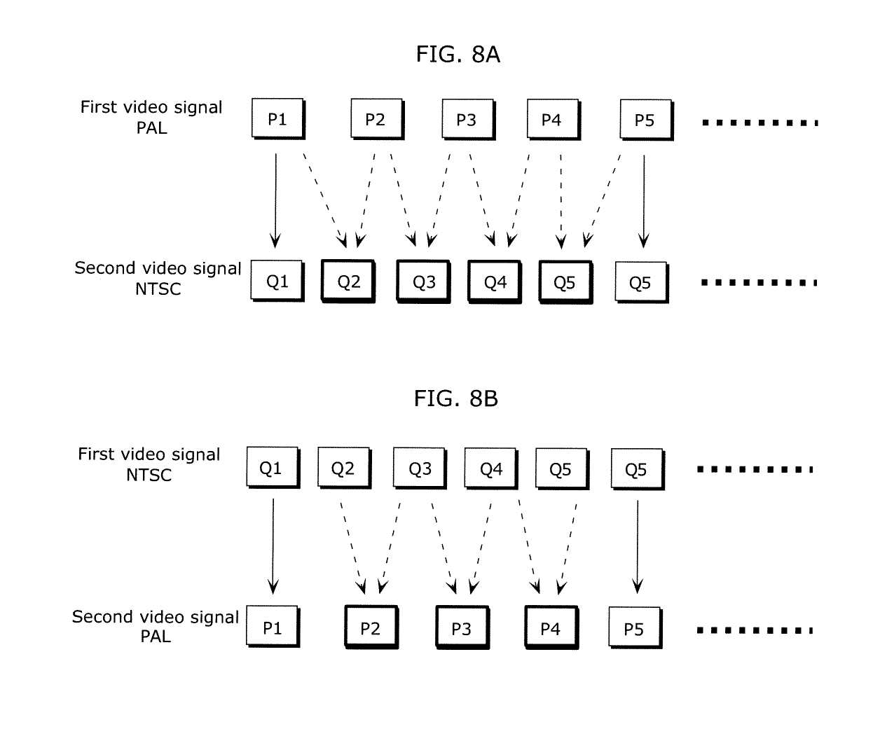

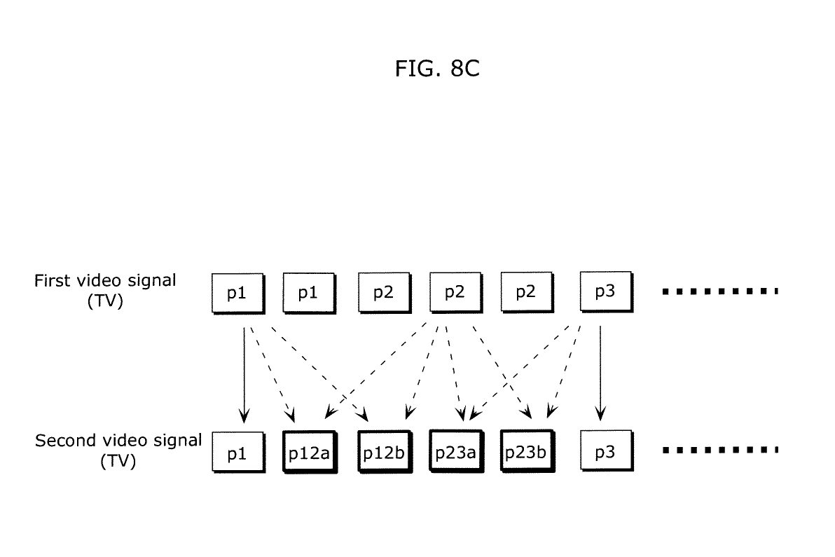

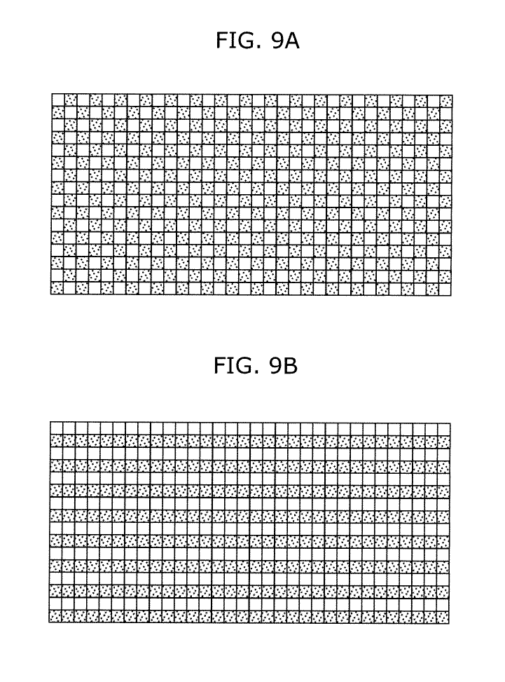

FIG. 8A shows a conversion from a PAL signal to an NTSC signal based on the motion-compensated interpolation. In FIG. 8A, the first video signal has a frame rate for the PAL TV broadcasting, and the frame rate is 50 fields a second. The second video signal has a frame rate for the NTSC TV broadcasting, and the frame rate is 60 fields a second.

In the second video signal, the fields Q1 and Q3 shown in a thin-line square represent images generated by duplication (interpolation). In contrast, in FIG. 8A, the fields Q2, Q3, and Q4 shown in a bold-line square represent interpolated images generated by motion-compensated interpolation. For example, the motion predicting unit 130a and the motion-compensated interpolating unit 130b generate, as an interpolated image which corresponds to a field time for the field Q2, the field Q2 for the second video signal in FIG. 8A based on at least one of the motion vector of the field P1 and the motion vector of the field P2. The fields Q3 to Q5 are also generated in a similar manner. Each of the interpolated images Q2 to Q5 reflects motion at a corresponding field time. This feature contributes to providing smooth motion, which improves image quality.

As described above, suppose the case where the first video signal has a frame rate for the PAL TV broadcasting, and the second video signal has a frame rate for the NTSC TV broadcasting. For each of viewpoints, the ME viewpoint control unit 120a obtains from the first video signal a pixel data corresponding to the viewpoint. The image generating unit (the motion predicting unit 130a and the motion-compensated interpolating unit 130b) generates for each of the viewpoints pixel data for interpolation from the obtained pixel data for each viewpoint, and generates an interpolated image. The video processing device generates an independent interpolated image for each viewpoint. Thus, in generating the interpolated image, the video processing device is free from an effect of a displacement amount corresponding to the parallax between the viewpoints. This feature successfully converts a signal from the PAL to the NTSC without deteriorating the quality of a 3D image.

Described next is: (C) a conversion from an NTSC signal to a PAL signal.

FIG. 8B shows a conversion from a NTSC signal to a PAL signal based on the motion-compensated interpolation. In FIG. 8B, the first video signal has a frame rate for the NTSC TV broadcasting, and the frame rate is 60 fields a second. The second video signal has a frame rate for the PAL TV broadcasting, and the frame rate is 50 fields a second.

In the second video signal, the fields P1 and P5 shown in a thin-line square represent (interpolated) images generated by duplication. In contrast, in FIG. 8B, the fields P2, P3, and P4 shown in a bold-line square represent interpolated images generated by motion-compensated interpolation. For example, the motion predicting unit 130a and the motion-compensated interpolating unit 130b generate, as an interpolated image which corresponds to a frame time for the field P2, the field P2 for the second video signal in FIG. 8A based on at least one of the motion vector of the field Q2 and the motion vector of the field Q3. The fields P2 to P4 are also generated in a similar manner. Each of the interpolated images P2 to P4 reflects motion at a corresponding field time. This feature contributes to providing smooth motion, which improves image quality.

As described above, suppose the case where the first video signal has a frame rate for the NTSC TV broadcasting, and the second video signal has a frame rate for the PAL TV broadcasting. For each of viewpoints, the ME viewpoint control unit 120a obtains from the first video signal pixel data corresponding to the viewpoint. The image generating unit (the motion predicting unit 130a and the motion-compensated interpolating unit 130b) generates for each of the viewpoints pixel data for interpolation from the obtained pixel data for each viewpoint, and generates an interpolated image. The video processing device generates an independent interpolated image for each viewpoint. Thus, in generating the interpolated image, the video processing device is free from an effect of a displacement amount corresponding to the parallax between the viewpoints. This feature successfully converts a signal from the NTSC to the PAL without deteriorating the quality of a 3D image.

In the exemplary operations in (A) to (C), described is the motion-compensated interpolation. Instead, linear interpolation and duplication-based interpolation can reduce the deterioration in the quality of a 3D image even though smooth motion might not be achieved.

Moreover, the exemplary operations in (A) to (C) may be applied to Embodiments 1 and 2. In addition, the image generating unit 130 may generate an interpolated image by applying, to the pixel data obtained by the viewpoint control unit 120 for each of viewpoints, at least one of (a) interpolation based on motion information, (b) linear interpolation, and (c) interpolation by frame duplication. As a matter of course, the usage may be dynamically changed.

It is noted that the first video signal and the second video signal may have the same frame rate. Having the same frame rate can make the motion of the first video signal smooth.

FIG. 8C shows how to generate a second video signal having the same frame rate as a first video signal has. The first video signal in FIG. 8C is, for example, the signal (the video signal after 2-3 pull down) at the bottom of FIG. 7A. The second video signal in FIG. 8C is, for example, the signal (the motion-compensation-interpolated video signal) at the bottom of FIG. 7B.

In the processing shown in FIG. 8C, the image generating unit (the motion predicting unit 130a and the motion-compensated interpolating unit 130b) generates the second video signal by replacing part of an image in the first video signal with an interpolated image by motion-compensated interpolation. Specifically, the image generating unit replaces the field p1 (the second p1) in the first video signal with the interpolated image p12a, one of the images P2 (the first p2) in the first video signal with the interpolated image p12b, the field p2 (the second p2) in the first video signal with the interpolated image p12b, . . . . Thanks to the processing, the second video signal can express smoother motion than the first video signal does. In FIG. 8C, the 2-3 pull-downed first video signal by duplication is converted to the second video signal based on the interpolated image having the motion vector. This feature contributes to reducing judder.

As described above, the video processing device according to Embodiment 3 can convert a video signal showing non-smooth and unnatural motion to a video signal showing smooth motion. It is noted that the first video signal showing non-smooth and unnatural motion shall not be limited to the signal (the video signal after 2-3 pull down) at the bottom of FIG. 7A. For example, the non-smooth and unnatural motion can develop when a frame in a video signal is interpolated by duplication. Only the image interpolated by the duplication of the video signal may be replaced with the interpolated image generated by the motion-compensated interpolation.

Furthermore, the image generating unit 130 may include a first resizing unit which enlarges or reduces an image in a vertical (longitudinal) direction, and a second resizing unit which enlarges or reduces an image in a horizontal (sideway) direction. At least one of the first resizing unit and the second resizing unit enlarges or reduces for each of viewpoint an interpolated image independently generated for the viewpoint. This feature allows the image generating unit 130 to easily handle the case where the resolution of an image in the first video signal differs from that of an image in the second video signal.

Moreover, in the video processing device in each of the embodiments, the frame rate for the second video signal including an interpolated image may be higher than, lower than, or the same as the frame rate for the first video signal.

It is noted that the image storage unit 100 may include a first storage area and a second storage area. Here, the first storage area stores one of images in a time period of one frame before the currently provided image in the first video signal, and the second storage area stores another one of the images in a time period of two frames before the currently provided image in the first video signal. The first and second storage areas may store, as the 1F delaying units 110 and 111 do, an image of one-frame time period before and an image of two-frame time periods before, or may store multiple images that are apart for the predetermined number of frames or for the predetermined number of fields. In addition, the image storage unit 100 may include three or more of the 1F delaying units to store multiple images. Here, each of the motion predicting unit and the motion compensating unit may selectively use any of the multiple images.

It is noted that the exemplary formats in FIGS. 2A to 2F and 3A to 3D show that there are two viewpoints. In the case where there are three or more viewpoints; namely multiple viewpoints, the formats may be expanded, depending on the number of the viewpoints.

As described above, a video processing device according to an implementation of the present invention generates an interpolated image from a first video signal including an image having a mix of pixels corresponding to viewpoints that are different from each other. The video processing device includes: a viewpoint control unit which obtains, for each of the viewpoints from the first video signal, pixel data corresponding to the viewpoint; and an image generating unit which generates an interpolated image by generating, for each of the viewpoints from the pixel data obtained by the viewpoint control unit, pixel data for interpolation for the viewpoint.

According to the structure, the viewpoint control unit obtains, for each viewpoint, pixel data corresponding to the viewpoint from the first video signal. The image generating unit generates, for each viewpoint, pixel data for interpolation from the pixel data obtained for the viewpoint, and further generates an interpolated image. The video processing device generates an independent interpolated image for each viewpoint. Thus, in generating the interpolated image, the video processing device is free from an effect of a displacement amount corresponding to the parallax between the viewpoints. This feature successfully prevents deteriorating the quality of a 3D image.

Here, the image generating unit may generate a second video signal which includes the pixel data (i) including the interpolated image, (ii) corresponding to an arrangement of pixels for a display panel, and (iii) corresponding to each of the viewpoints, and the viewpoint control unit may obtain the pixel data of the first video signal for each of the viewpoints so that the obtained pixel data matches an arrangement of pixels for the second video signal.

These features make it possible to generate an interpolated image without deteriorating the quality of a 3D image, and to efficiently convert the pixel arrangement of the first video signal to the pixel arrangement for the second signal (format conversion) in the case where the pixel arrangement differs between the first video signal and the second video signal.

Here, the viewpoint control unit may associate a pixel address in an arrangement of the pixels for the first video signal with a pixel address in the arrangement of the pixels for the second video signal so as to obtain the pixel data of the first video signal for each of the viewpoints from the first video signal based on the pixel address in the arrangement of the pixels for the second video signal.

This feature makes it possible to make a format conversion, that is to convert the pixel arrangement of the first video signal to the pixel arrangement for the second signal, fast by the viewpoint control unit associating the pixel addresses with each other. In addition, a memory to store the image in the second video signal eliminates the need for doubly-storing images before and after the format conversion. This feature makes it possible to minimize the memory area for the format conversion, which contributes to reducing the cost.

Here, the video processing device may further include a motion information detecting unit which detects, for each of the viewpoints from the pixel data obtained by the viewpoint control unit, motion information of an image for the viewpoint. The image generating unit may generate the interpolated image for each of the viewpoints by generating pixel data for interpolation for the viewpoint based on the motion information for the viewpoint.

This feature makes it possible to accurately detect motion information, and to generate an interpolated image without deteriorating the quality of an interpolated image and therefore a 3D image.

Here, the viewpoint control unit may include: a first viewpoint control unit which obtains, for each of the viewpoints from the first video signal, the pixel data corresponding to the viewpoint, and to provides the obtained pixel data to the image generating unit; and a second viewpoint control unit which obtains, for each of the viewpoints from the first video signal, the pixel data corresponding to the viewpoint, and provides the obtained pixel data to the motion information detecting unit.

This feature makes it possible to execute pipelining the motion detection by the motion detecting unit and the image generation by the image generating unit, which contributes to achieving a higher frame rate. For example, the feature is suitable to convert a frame rate to a faster one than a double speed and a conversion of film footage to a frame rate of a display panel.

Here, the video processing device may include an image storage unit which temporarily stores one or more frames of image found in the first video signal. The viewpoint control unit may obtain, for each of the viewpoints from the image storage unit, the pixel data corresponding to the viewpoint, and may provide the obtained pixel data to the image generating unit.

This feature successfully converts a format so that the pixel arrangement of the first video signal converts to the pixel arrangement for the second video signal, without deteriorating the quality of a 3D image.

Here, the video processing device may include an image storage unit which temporarily stores the first video signal. The image storage unit may store one or more frames of image found in the first video signal. The first viewpoint control unit may obtain, for each of the viewpoints from the image storage unit, the pixel data corresponding to the viewpoint, and may provide the obtained pixel data to the image generating unit. The second viewpoint control unit may obtain, for each of the viewpoints from the image storage unit, the pixel data corresponding to the viewpoint, and may provide the obtained pixel data to the motion information detecting unit.

This feature makes it possible to execute pipelining the motion detection by the motion detecting unit and the image generation by the image generating unit, which contributes to achieving a higher frame rate. For example, the feature is suitable to convert a frame rate to a faster one than a double speed and a conversion of film footage to a frame rate of a display panel.

Here, the first viewpoint control unit may associate a pixel address in an arrangement of the pixels for the first video signal with a pixel address in an arrangement of pixels for a second video signal so as to obtain the pixel data of the first video signal for each of the viewpoints from the first video signal based on the pixel address in the arrangement of the pixels for the second video signal.

This feature makes it possible to make a format conversion; that is to convert the pixel arrangement of the first video signal to the pixel arrangement for the second signal, fast by an address conversion of the storage area in the image storage unit. In addition, the image storage unit eliminates the need for doubly-storing images before and after the format conversion. This feature makes it possible to minimize the memory area for the format conversion, which contributes to reducing the cost.

Here, the image generating unit may generate the interpolated image by applying, to the pixel data obtained by the viewpoint control unit for each of the viewpoints, at least one of (a) interpolation based on motion information, (b) linear interpolation, and (c) interpolation by frame duplication.

This feature makes it possible to decrease a processing amount and a processing load in generating an interpolated image when (b) the interpolated image is generated by the linear interpolation. Hence, the hardware size is successfully reduced. This feature makes it possible to decrease a processing amount and a processing load in generating an interpolated image when (c) the interpolated image is generated by duplication. Consequently, the interpolated image is generated without increasing the hardware size. The interpolation using at least one of (a) to (c) successfully offers a flexible response over the processing amount and the processing speed.

Here, the image generating unit may insert the interpolated image between pictures in the first video signal to generate the second video signal. The second video signal may have a frame rate higher than that of the first video signal.

Here, the frame rate of the second video signal is twice or four times as high as that of the first video signal.

This feature makes it possible to convert a frame rate as fast as an n-time speed (for example, a double frame-rate conversion and a quadruple frame-rate conversion).

Here, the first video signal may have a frame rate for movie film, and the second video signal may have a frame rate for TV broadcasting or for a display panel.

This feature makes it possible to convert a video signal of movie film to an image having a frame rate of a display panel.

Here, the first video signal may have a frame rate for the PAL TV broadcasting, and the second video signal may have a frame rate for the NTSC TV broadcasting.

This feature makes it possible to convert a PAL video signal to an NTSC video signal.

Here, the image generating unit may generate the second video signal including an image having the interpolated image and part of the first video signal. The second video signal may have a frame rate lower than that of the first video signal.

This feature makes it possible to lower the frame rate of the first video signal, and to replace the frame with an interpolated image while maintaining the same frame rate.

Here, the first video signal may have a frame rate for the NTSC TV broadcasting, and the second video signal may have a frame rate for the PAL TV broadcasting.

This feature makes it possible to convert an NTSC video signal to a PAL video signal.

Here, the image generating unit may generate a second video signal including the interpolated image. The second video signal may have the same frame rate as that of the first video signal. The image generating unit may replace part of an image in the first video signal with the interpolated image so as to generate the second video signal. This feature makes it possible to perform de-juddering on, for example, a 2-3 pull-downed first video signal by duplication, using an interpolated image having a motion vector. Consequently, the motion of the second video signal can be smoother than that of the first video signal.

A video processing method according to an aspect of the present invention involves generating an interpolated image from a first video signal including an image having a mix of pixels corresponding to viewpoints that include at least a first viewpoint and a second viewpoint and are different from each other. The video processing method includes: obtaining, from the first video signal, pixel data corresponding to the first viewpoint; generating, from the obtained pixel data corresponding to the first viewpoint, pixel data for interpolation corresponding to the first viewpoint; obtaining, from the first video signal, pixel data corresponding to the second viewpoint; generating, from the obtained pixel data corresponding to the second viewpoint, pixel data for interpolation corresponding to the second viewpoint; and generating an interpolated image from the pixel data for interpolation corresponding to the first viewpoint and the pixel data for interpolation corresponding to the second viewpoint.

According to the structure, the method involves (i) obtaining, for each of viewpoints, pixel data corresponding to the viewpoint from the first video signal, (ii) generating, for each of the viewpoints, pixel data for interpolation from the pixel data obtained for the viewpoint, and (iii) further generating an interpolated image. Since the method involves generating an independent interpolated image for each viewpoint, the method is free from an effect of a displacement amount between viewpoints (or a displacement amount). This feature contributes to achieving a higher frame rate without deteriorating the quality of a 3D image.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present invention is suitable to a video processing device and a video processing method which generate an interpolated image from a first video signal including an image having a mix of pixels corresponding to multiple different viewpoints.

1. A video processing device which generates an interpolated image from a first video signal including an image having a mix of pixels corresponding to viewpoints that are different from each other, the video processing device comprising:
a viewpoint control unit configured to obtain, for each of the viewpoints from the first video signal, pixel data corresponding to the viewpoint; and
an image generating unit configured to generate an interpolated image by generating, for each of the viewpoints from the pixel data obtained by the viewpoint control unit, pixel data for interpolation for the viewpoint.

2. The picture processing device according to claim 1,
wherein the image generating unit is configured to generate a second video signal which includes the pixel data (i) including the interpolated image, (ii) corresponding to an arrangement of pixels for a display panel, and (iii) corresponding to each of the viewpoints, and
the viewpoint control unit is configured to obtain the pixel data of the first video signal for each of the viewpoints so that the obtained pixel data matches an arrangement of pixels for the second video signal.

3. The picture processing device according to claim 2,
wherein the viewpoint control unit is configured to associate a pixel address in an arrangement of the pixels for the first video signal with a pixel address in the arrangement of the pixels for the second video signal so as to obtain the pixel data of the first video signal for each of the viewpoints from the first video signal based on the pixel address in the arrangement of the pixels for the second video signal.

4. The picture processing device according to claim 1, further comprising
a motion information detecting unit configured to detect, for each of the viewpoints from the pixel data obtained by the viewpoint control unit, motion information of an image for the viewpoint,
wherein the image generating unit is configured to generate the interpolated image for each of the viewpoints by generating pixel data for interpolation for the viewpoint based on the motion information for the viewpoint.

5. The picture processing device according to claim 4,
wherein the viewpoint control unit includes:
a first viewpoint control unit configured to obtain, for each of the viewpoints from the first video signal, the pixel data corresponding to the viewpoint, and to provide the obtained pixel data to the image generating unit; and
a second viewpoint control unit configured to obtain, for each of the viewpoints from the first video signal, the pixel data corresponding to the viewpoint, and to provide the obtained pixel data to the motion information detecting unit.

6. The picture processing device according to claim 2, further comprising
an image storage unit configured to temporarily store one or more frames of image found in the first video signal,
wherein the viewpoint control unit is configured to obtain, for each of the viewpoints from the image storage unit, the pixel data corresponding to the viewpoint, and to provide the obtained pixel data to the image generating unit.

7. The picture processing device according to claim 5, further comprising
an image storage unit configured to temporarily store the first video signal,
wherein the image storage unit is configured to store one or more frames of image found in the first video signal,
the first viewpoint control unit is configured to obtain, for each of the viewpoints from the image storage unit, the pixel data corresponding to the viewpoint, and to provide the obtained pixel data to the image generating unit, and
the second viewpoint control unit is configured to obtain, for each of the viewpoints from the image storage unit, the pixel data corresponding to the viewpoint, and to provide the obtained pixel data to the motion information detecting unit.

8. The picture processing device according to claim 7,
wherein the first viewpoint control unit is configured to associate a pixel address in an arrangement of the pixels for the first video signal with a pixel address in an arrangement of pixels for a second video signal so as to obtain the pixel data of the first video signal for each of the viewpoints from the first video signal based on the pixel address in the arrangement of the pixels for the second video signal.

9. The picture processing device according to claim 1,
wherein the image generating unit is configured to generate the interpolated image by applying, to the pixel data obtained by the viewpoint control unit for each of the viewpoints, at least one of (a) interpolation based on motion information, (b) linear interpolation, and (c) interpolation by frame duplication.

10. The picture processing device according to claim 2,
wherein the image generating unit is configured to generate the interpolated image by applying, to the pixel data obtained by the viewpoint control unit for each of the viewpoints, at least one of (a) interpolation based on motion information, (b) linear interpolation, and (c) interpolation by frame duplication.

11. A video processing method for generating an interpolated image from a first video signal including an image having a mix of pixels corresponding to viewpoints that include at least a first viewpoint and a second viewpoint and are different from each other, the video processing method comprising:
obtaining, from the first video signal, pixel data corresponding to the first viewpoint;
generating, from the obtained pixel data corresponding to the first viewpoint, pixel data for interpolation corresponding to the first viewpoint;
obtaining, from the first video signal, pixel data corresponding to the second viewpoint;
generating, from the obtained pixel data corresponding to the second viewpoint, pixel data for interpolation corresponding to the second viewpoint; and
generating an interpolated image from the pixel data for interpolation corresponding to the first viewpoint and the pixel data for interpolation corresponding to the second viewpoint.
